(19) United States
(12) Patent Application Publication
(10) Pub. No.: US 2016/0218338 A1
(43) Pub. Date: Jul. 28, 2016

(54) BATTERY PACK VENTING ASSEMBLY AND METHOD

(71) Applicant: FORD GLOBAL TECHNOLOGIES, LLC, Dearborn, MI (US)

(72) Inventors: Asif Iqbal, Macomb, MI (US); Daniel Miller, Dearborn, MI (US); Adi Peshkess, Canton, MI (US); James Lawrence Swoish, Northville, MI (US)

(21) Appl. No.: 14/602,582

(22) Filed: Jan. 22, 2015

(51) Int. Cl. H01M 2/12

(52) U.S. Cl. CPC H01M 2/1264; H01M 2220/20

(57) ABSTRACT

An exemplary assembly includes, among other things, a plurality of vent chambers each associated with a battery array. The assembly further includes a vent conduit disposed on the plurality of vent chambers to receive vented fluid from the plurality of vent chambers.

### TECHNICAL FIELD

This disclosure is directed toward venting battery cells within a battery pack of an electrified vehicle.

### BACKGROUND

Generally, electrified vehicles differ from conventional motor vehicles because electrified vehicles can be selectively driven using one or more battery-powered electric machines. Conventional motor vehicles, by contrast, are driven exclusively by an internal combustion engine. Electric machines can drive the electrified vehicles instead of, or in addition to, an internal combustion engine. Example electrified vehicles include all-electric vehicles, hybrid electric vehicles (HEVs), plug-in hybrid electric vehicles (PHEVs), fuel cell vehicles, and battery electric vehicles (BEVs).

A powertrain of an electrified vehicle typically includes a battery pack having battery cells that store electrical power for the electric machine. From time to time, gas within the interiors of battery cells can undesirably expand. The battery cells include vents to, if required, allow the expanding gas to escape from the interiors. After moving through the vent, the expanding gas is directed outside of the vehicle.

### SUMMARY

An assembly according to an exemplary aspect of the present disclosure includes, among other things, a plurality of vent chambers each associated with a battery array. A vent conduit is disposed on the plurality of vent chambers. The vent conduit receives vented fluid from the plurality of vent chambers.

In a further non-limiting embodiment of the foregoing assembly, the vent conduit extends longitudinally along a vent conduit axis, and the vent chambers extend longitudinally along respective vent chamber axes that are transverse to the vent conduit axis.

In a further non-limiting embodiment of any of the foregoing assemblies, the plurality of vent chambers are biased toward the battery arrays, and the vent conduit is separately biased toward the vent chambers.

In a further non-limiting embodiment of any of the foregoing assemblies, the assembly includes downwardly facing openings of the vent conduit that correspond to upwardly facing openings of the plurality of vent chambers.

In a further non-limiting embodiment of any of the foregoing assemblies, the assembly includes a sealant between a perimeter of the downwardly facing openings and a perimeter of the upwardly facing openings.

In a further non-limiting embodiment of any of the foregoing assemblies, the vent conduit is provided by a channel secured to a cover.

In a further non-limiting embodiment of any of the foregoing assemblies, the channel is secured to a downwardly facing surface of the cover.

In a further non-limiting embodiment of any of the foregoing assemblies, the channel comprises a floor and walls extending from opposing lateral sides of the floor. Downwardly facing openings are within the floor.

In a further non-limiting embodiment of any of the foregoing assemblies, the channel is a formed metal.

In a further non-limiting embodiment of any of the foregoing assemblies, the channel is welded to the cover.

An assembly according to another exemplary aspect of the present disclosure includes, among other things, a plurality of vent chambers each associated with a battery array. The assembly further includes a vent conduit biased toward the plurality of vent chambers to receive vented fluid from the plurality of vent chambers.

In a further non-limiting embodiment of the foregoing assembly, the vent conduit extends longitudinally along a vent conduit axis, and the vent chambers extend longitudinally along respective vent chamber axes that are transverse to the vent conduit axis.

In a further non-limiting embodiment of any of the foregoing assemblies, the vent conduit is disposed on top of the vent chambers.

In a further non-limiting embodiment of any of the foregoing assemblies, the assembly includes downwardly facing openings of the vent conduit that correspond to upwardly facing openings of the plurality of vent chambers.

In a further non-limiting embodiment of any of the foregoing assemblies, the vent conduit is provided by a channel secured to a downwardly facing surface of a cover.

A method according to yet another exemplary aspect of the present disclosure includes, among other things, communicating a fluid vented from a battery cell to a vent chamber, communicating the fluid from the vent chamber to a vent conduit, and biasing the vent conduit against the vent chamber.

In a further non-limiting embodiment of the foregoing method, the method includes biasing the vent chamber against the battery cell.

In a further non-limiting embodiment of any of the foregoing methods, the method includes biasing the vent conduit, the vent chamber, and the battery cell toward a cold plate.

In a further non-limiting embodiment of any of the foregoing methods, the method includes communicating the fluid along a length of the vent chamber in a first direction, communicating the fluid upward to the vent conduit, and communicating the fluid along the length of the vent conduit in a second direction transverse to the first direction.

In a further non-limiting embodiment of any of the foregoing methods, the biasing is in a first direction, and the fluid communicates from the vent chamber to the conduit in a second direction opposite the first direction.

The embodiments, examples and alternatives of the preceding paragraphs, the claims, or the following figures and description, including any of their various aspects or respective individual features, may be taken independently or in any combination. Features described in connection with one embodiment are applicable to all embodiments, unless such features are incompatible.

### DESCRIPTION OF THE FIGURES

The various features and advantages of the disclosed examples will become apparent to those skilled in the art from the detailed description. The figures that accompany the detailed description can be briefly described as follows:

FIG. 1 shows a schematic view of an example electrified vehicle.

FIG. 2 shows a partially schematic, perspective view of a battery pack from the electrified vehicle of FIG. 1.

FIG. 3 shows a partially exploded view of the battery pack of FIG. 2.

FIG. 4 shows another partially exploded view of portions of the battery pack of FIG. 2.

FIG. 5 shows a perspective view of a battery cell from the battery pack of FIG. 2.

FIG. 6 shows a perspective view of an array vent chamber from the battery pack of FIG. 2

FIG. 7 shows a perspective view of a portion of a vent conduit from the battery pack of FIG. 2.

FIG. 8 shows a downwardly facing surface of a cover of the battery pack of FIG. 2.

FIG. 9 shows a perspective section, view at Line 9-9 in FIG. 7.

### DETAILED DESCRIPTION

This disclosure relates generally to venting fluid along a vent path from an interior of a battery cell. In example embodiments, the vent path is provided using relatively few components.

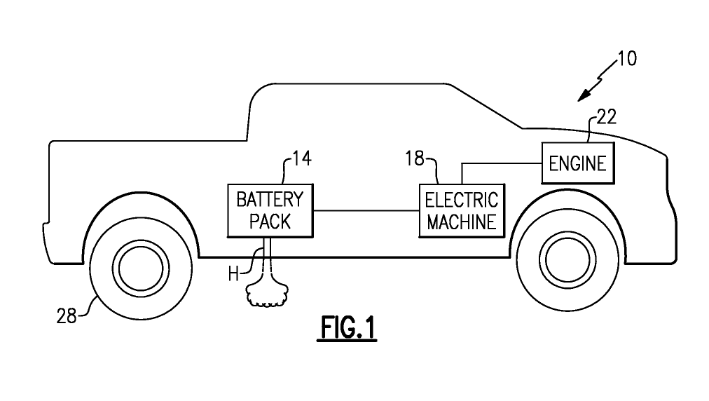

Referring to FIG. 1, an example electrified vehicle 10 includes a battery pack 14 to power an electric machine 18. The vehicle 10 further includes an internal combustion engine 22.

The electric machine 18 or the engine 22 selectively drives wheels 28 of the vehicle 10. The electric machine 18 receives electric power from the battery pack 14 and converts the electric power to torque to drive the wheels 28.

Periodically, expanding gases from the battery pack 14 may require venting. The vehicle 10 includes a hose H for venting these gases from the battery pack 14 to a position outside the vehicle 10.

The example vehicle 10 is hybrid electric vehicle. In hybrid electric examples, the electric machine 18 may selectively operate as a generator to recharge the battery pack 14. In other examples, vehicle 10 is an all electric vehicle.

The electric machine 18 may include a motor and a separate generator or a combined motor-generator.

In the example electrified vehicle 10, the battery pack 14 is mounted to a load floor beneath a second row seat.

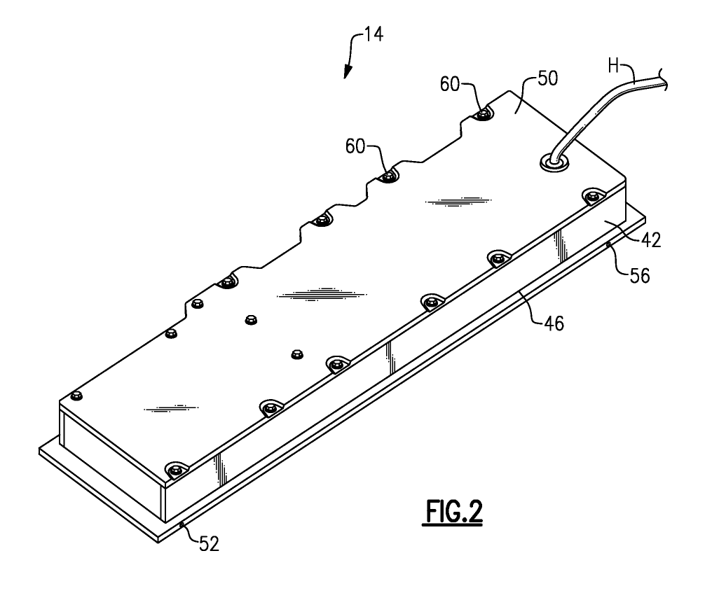

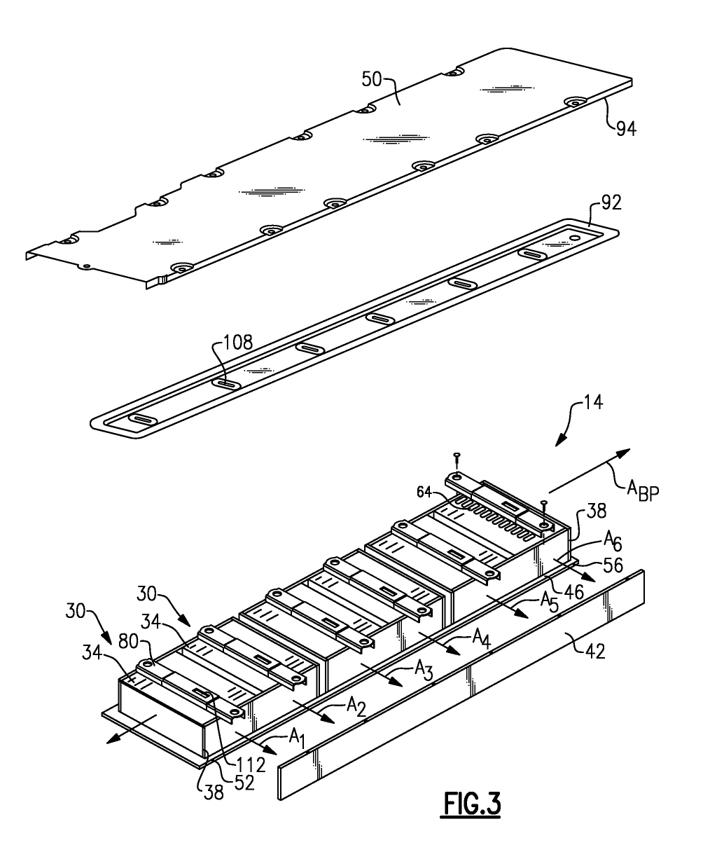

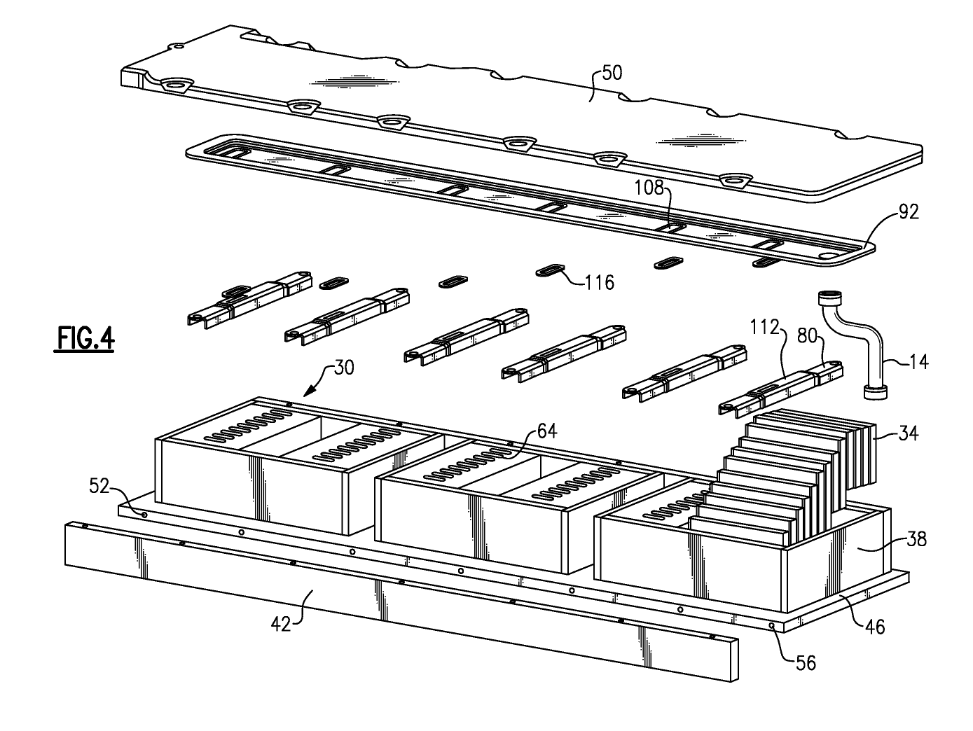

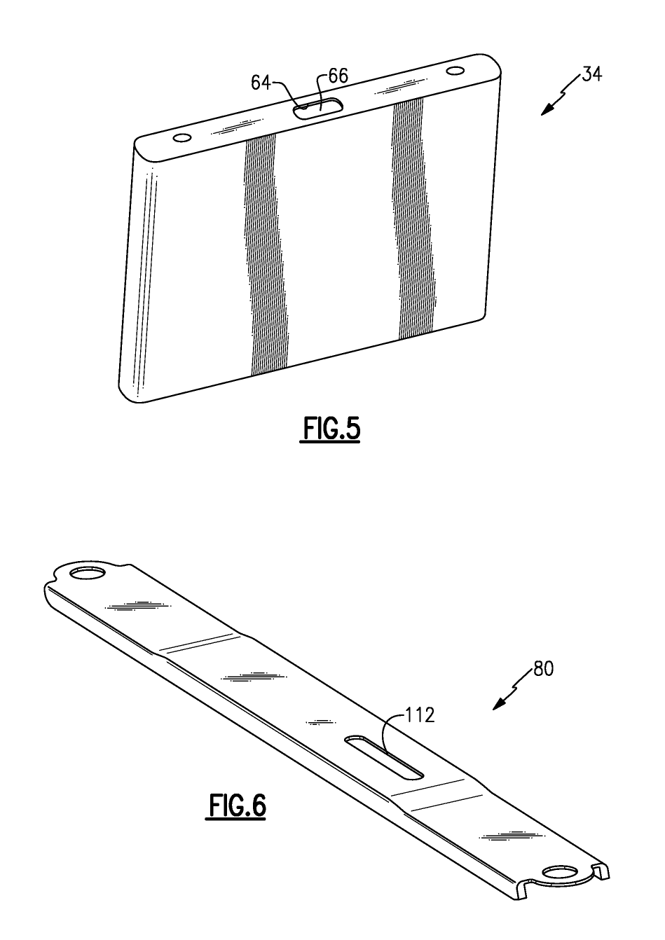

Referring now to FIGS. 2 to 5, the example battery pack 14 includes multiple arrays 30 of individual battery cells 34. The arrays 30 of the battery pack 14 are positioned along a battery pack axis A_{BP}. The battery pack 14 can further include a bussed electric center (BEC) and a battery electronic control module (BECM) (not shown).

The battery cells 34 of each of the arrays 30 are disposed along a respective battery array axis A₁to A₆. The battery cells 34 are lithium ion cells in this example.

The battery pack 14 further includes structural plates, such as end plates 38, side plates 42, a cold plate 46, and a cover 50. The structural plates and the battery cells 34 are disposed on the cold plate 46.

The end plates 38 can connect to the side plates 42 with mechanical fasteners, for example. This connection holds the positions of the end plates 38 relative to each other. The arrays 30 can be compressed between end plates 38 along the battery pack axis A_{BP}. The arrays 30 can be compressed between the side plates 42 along the respective battery array axis A₁to A₆.

The example battery pack 14 is cooled via liquid coolant communicated through the cold plate 46. Liquid coolant moves from a coolant supply through an inlet 52 to a coolant path within the cold plate 46. The liquid coolant circulates through the coolant path to absorb thermal energy from the cells 34 and other structures. The liquid coolant then exits the cold plate 46 at an outlet 56.

The cold plate 46 is a type of heat exchanger. In other examples, heat exchangers other than the cold plate 46 could be used.

The cover 50 is biased downward toward the cold plate 46 to compress the battery cells 34 against the cold plate 46. Mechanical fasteners 60 can be used to cause the cover 50 to exert a downward biasing force on the battery cells 34.

The battery cells 34 include vent openings 64. The vent openings 64 are covered by a membrane 66 during normal operation of the battery pack 14. Periodically, gases within the battery cells 34 may expand and require venting. In this example, the expansion of these gases within the battery cells 34 forces open the membrane 66 providing an open path for gases to move from an interior of the battery cells 34.

The example battery pack 14 communicate gases that have moved through the vent opening 64 along a vent path to move those gases to a position outside the vehicle 10. The vent path includes, in this example, array vent chambers 80, a vent conduit 84, and a hose 88.

The battery pack 14 includes a plurality of the array vent chambers 80 each associated with a respective battery array 30. The vent chambers 80 are positioned atop the battery arrays 30 and cover the vent openings 64 within the battery cells 34 of the respective battery array 30.

The vent conduit 84 is disposed atop the array vent chambers 80 and extends along a length of the battery pack 14. The example vent conduit 84 interfaces with each of the array vent chambers 80 of the battery pack 14. The vent conduit 84 is provided by the cover 50 and a channel 92 secured to a downwardly facing surface 94 of the cover 50.

Fluid vented from the battery cells 34 moves through the vent opening 64 into an open area provided between the array vent chamber 80 and the battery cells 34 of the respective battery array 30. The fluid then moves to the vent conduit 84, which communicates the vented fluid to the hose H. The fluid then moves through the hose H to a position outside a cabin of the vehicle 10.

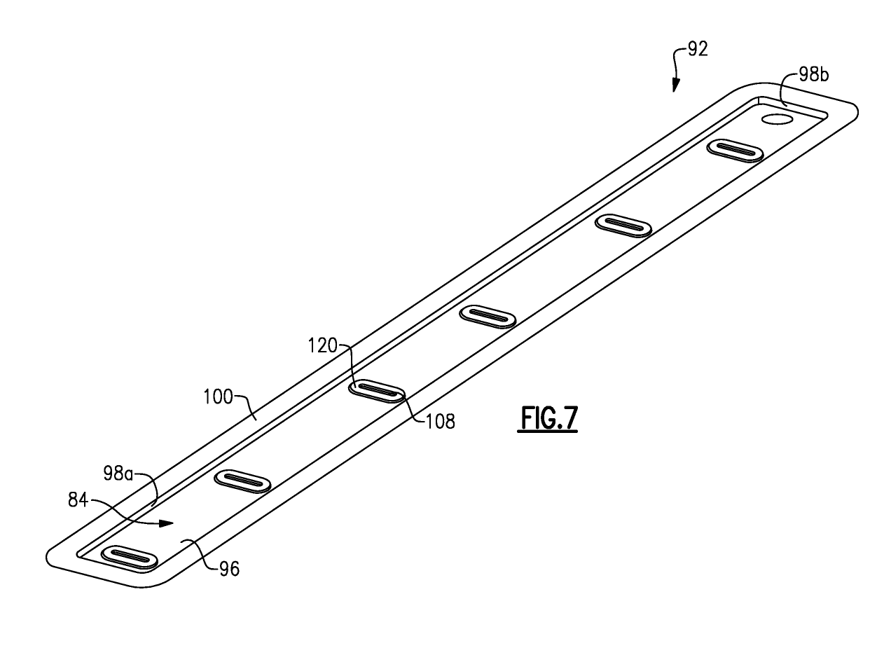

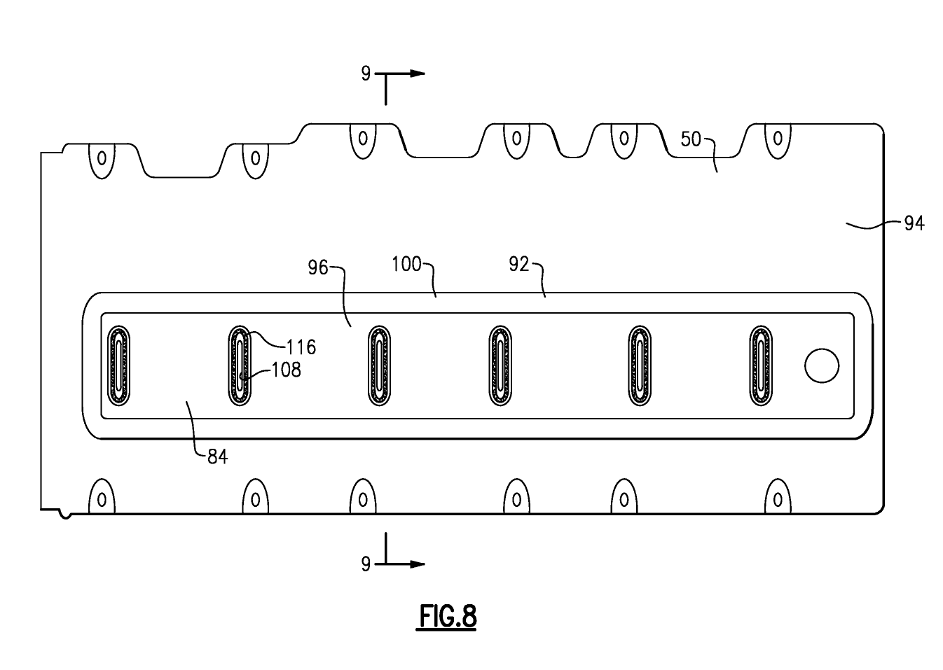

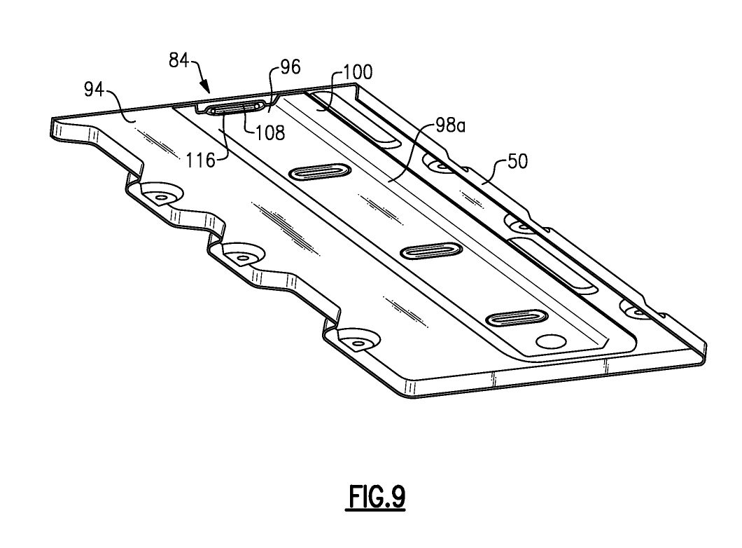

Referring now to FIGS. 6 to 9 with continuing reference to FIGS. 2 to 4, the channel 92 includes a floor 96, sidewalls 98a, endwalls 98b, and a flange 100. The sidewalls 98a extend upwardly from the floor 96 to the flange 100. The endwalls 98b extend upwardly from the floor 96 to the flange 100. The channel 92 can be a stamped metal, for example. In other examples, the channel 92 is a metal casting, a polymer material.

The flange 100 is secured to the cover 50 to hold the channel 92 relative to the cover 50. The flange 100 is spot welded to the cover 50 in some examples. In other examples, the channel 92 is adhesively bonded to the cover 50.

A sealant may be added at the interfacing areas of the flange 100 and the cover 50 prior to, or in connection with, securing the channel 92 to the cover 50. The sealant blocks fluid from moving through the interfacing areas of the flange 100 and the cover 50.

The floor 96 of the channel 92 includes downwardly facing openings 108 that correspond to upwardly facing openings 112 provided by the plurality of vent chambers 80. Flow from within the array vent chambers 80 moves to the vent conduit 84 through the openings 108 and 112. Notably, as the vent conduit 84 is disposed upon the array vent chambers 80, the flow moves upwardly through the openings 108 and 112. Flow of vented fluid then moves from the vent conduit 84 to the hose H where it is communicated outside the vehicle 10.

A sealant 116 can be placed between a perimeter of the downwardly facing openings 108 and a perimeter of the upwardly facing openings 112 to limit flow through this interface. In this example, a perimeter of the downwardly facing openings includes a raised area 120 to accommodate the sealant 116.

When the battery pack 14 is assembled, the channel 92 and the array vent chambers 80 are sandwiched between the cover 50 and the battery cells 34. As the cover 50 is secured via the mechanical fasteners 72, the vent conduit 84 is compressed against the array vent chambers 80, which facilitates a sealed relationship between the vent conduit 84 and the array vent chambers 80 in the area of the openings 108.

The vent chambers 80 extend along respective axes aligned with the axes A₁ to A₆ of the battery arrays 30. The vent conduit 84 extends longitudinally along a vent conduit axis that is aligned with the axis A_{BP}, but is transverse to the axes A₁ to A₆. In this example, the vent conduit axis is perpendicular to the axes A₁ to A₆.

Features of the disclosed examples include a venting assembly and method utilizing a relatively low number of parts compared to prior art designs. This provides a relatively low cost assembly for effectively venting fluid from battery cells to a location outside a vehicle cabin. The assembly reduces the components required to vent, which facilitates vertically packaging the assembly within the vehicle. The vent conduit is at least partially provided by a channel structure having a top hat type configuration. A single channel can receive fluid from a plurality of different array vent chambers.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. An assembly, comprising:
a plurality of vent chambers each associated with a battery array; and
a vent conduit disposed on the plurality of vent chambers to receive vented fluid from the plurality of vent chambers.

2. The assembly of claim 1, wherein the vent conduit extends longitudinally along a vent conduit axis, and the vent chambers extend longitudinally along respective vent chamber axes that are transverse to the vent conduit axis.

3. The assembly of claim 1, wherein the plurality of vent chambers are biased toward the battery arrays, and the vent conduit is separately biased toward the vent chambers.

4. The assembly of claim 1, further comprising downwardly facing openings of the vent conduit that correspond to upwardly facing openings of the plurality of vent chambers.

5. The assembly of claim 4, further comprising a sealant between a perimeter of the downwardly facing openings and a perimeter of the upwardly facing openings.

6. The assembly of claim 4, wherein the vent conduit is provided by a channel secured to a cover.

7. The assembly of claim 6, wherein the channel is secured to a downwardly facing surface of the cover.

8. The assembly of claim 6, wherein the channel comprises a floor and walls extending from opposing lateral sides of the floor, the downwardly facing openings within the floor.

9. The assembly of claim 6, wherein the channel is a formed metal.

10. The assembly of claim 6, wherein the channel is welded to the cover.

11. An assembly, comprising:
a plurality of vent chambers each associated with a battery array; and
a vent conduit biased toward the plurality of vent chambers to receive vented fluid from the plurality of vent chambers.

12. The assembly of claim 11, wherein the vent conduit extends longitudinally along a vent conduit axis, and the vent chambers extend longitudinally along respective vent chamber axes that are transverse to the vent conduit axis.

13. The assembly of claim 11, wherein the vent conduit is disposed on top of the vent chambers.

14. The assembly of claim 11, further comprising downwardly facing openings of the vent conduit that correspond to upwardly facing openings of the plurality of vent chambers.

15. The assembly of claim 11, wherein the vent conduit is provided by a channel secured to a downwardly facing surface of a cover.

16. A method, comprising:
communicating a fluid vented from a battery cell to a vent chamber;
communicating the fluid from the vent chamber to a vent conduit; and
biasing the vent conduit against the vent chamber.

17. The method of claim 16, further comprising biasing the vent chamber against the battery cell.

18. The method of claim 17, further comprising biasing the vent conduit, the vent chamber, and the battery cell toward a cold plate.

19. The method of claim 16, further comprising communicating the fluid along a length of the vent chamber in a first direction, communicating the fluid upward to the vent conduit, and communicating the fluid along a length of the vent conduit in a second direction transverse to the first direction.

20. The method of claim 16, wherein the biasing is in a first direction, and the fluid communicates from the vent chamber to the conduit in a second direction opposite the first direction.
